(19) United States
(12) Patent Application Publication
(10) Pub. No.: US 2025/0165710 A1
(43) Pub. Date: May 22, 2025

(54) METHOD AND ANALYSIS DEVICE THEREOF FOR ANALYZING DEGREE OF CORRELATION BETWEEN IMAGE GENERATED BY GENERATIVE MODEL AND TEXT PROMPT

(71) Applicant: ELECTRONICS AND TELECOMMUNICATIONS RESEARCH INSTITUTE, Daejeon (KR)

(72) Inventors: Sung-Won MOON, Daejeon (KR); Do-Won NAN, Daejeon (KR); Wonyoung YOO, Daejeon (KR); Jung Soo LEE, Daejeon (KR); Jiwon LEE, Daejeon (KR)

(21) Appl. No.: 18/815,057

(22) Filed: Aug. 26, 2024

(30) Foreign Application Priority Data
Nov. 21, 2023 (KR) 10-2023-0162432

(51) Int. Cl. G06F 40/279; G06F 40/40; G06T 7/11; G06T 11/00

(52) U.S. Cl. CPC G06F 40/279; G06F 40/40; G06T 7/11; G06T 11/00

(57) ABSTRACT

A method and an analysis device thereof for analyzing a degree of correlation between an image generated by a generative model and a text prompt are proposed. The method includes receiving the text prompt by an analysis device, inputting the text prompt into the text-to-image generative model by the analysis device, calculating, by the analysis device, degrees of correlation between text elements in the text prompt and conditional latent vectors for each text element, and determining, by the analysis device, at least one text element among the text elements for generating the image if the degrees of correlation for the at least on text element is greater than a threshold value, wherein the conditional latent vectors are generated in a process of generating the image by the text-to-image generative model.

### CROSS REFERENCE TO RELATED APPLICATION

This application claims the benefit under 35 U.S.C. § 119(a) of Korean Patent Application No. 10-2023-0162432, filed on Nov. 21, 2023, in the Korean Intellectual Property Office, the entire disclosure of which is incorporated herein by reference for all purposes.

### BACKGROUND

### 1. Field of the Invention

The following description relates to a technique for selecting a text prompt significant for generating a target image generated by a generative model.

### 2. Description of the Related Art

A text-to-image generative model is a model for generating an image by receiving certain text as input. The text-to-image generative model receives input of a certain text prompt from a user and generates a target image. The user determines a text prompt based on a result and experience of the generated image.

A model (e.g., a CLIP interrogator) for generating a caption on the basis of an input image has been developed. However, the model generates the caption on the basis of the entire image. Hence, the model has limitations in constructing an effective text prompt for generating an image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method for analyzing a degree of correlation between an image and a text prompt, includes receiving the text prompt by an analysis device, inputting the text prompt into the text-to-image generative model by the analysis device, calculating, by the analysis device, degrees of correlation between text elements in the text prompt and conditional latent vectors for each text element, and determining, by the analysis device, at least one text element among the text elements for generating the image if the degrees of correlation for the at least on text element is greater than a threshold value, wherein the conditional latent vectors are generated in a process of generating the image by the text-to-image generative model.

In another aspect, there is provided an analysis device for analyzing a degree of correlation between a generated image and a text prompt, includes an interface device configured to receive input of the text prompt, a storage device configured to store a text-to-image generative model for generating an image on the basis of text information, and a calculation device configured to select at least one text element among the text elements in the text prompt based on degrees of correlation between conditional latent vectors and the at least one text element, wherein the conditional latent vectors are generated in a process of generating the image by the text-to-image generative model which input the text prompt.

### BRIEF DESCRIPTION OF THE DRAWINGS

FIG. 1 is a view illustrating an example of a system for analyzing correlations between a generated image and a text prompt.

FIG. 2 is a view illustrating an example of a process of analyzing correlations between a generated image and a text prompt.

FIGS. 3A and 3B are views illustrating examples of cross attention maps between images and respective text prompts thereof, which are generated with a text-to-image generative model.

FIGS. 4A to 4C are views illustrating another example of cross attention maps between an image and a text prompt thereof, which are generated with the text-to-image generative model.

FIG. 5 is a view illustrating an example of area detection or segmentation using a generated image and an attention map.

FIG. 6 is a view illustrating an example of an analysis device for analyzing correlations between a generated image and a text prompt.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

In the following detailed description below, various modifications may be made and various exemplary embodiments may be provided, so particular exemplary embodiments will be illustrated in the drawings and described in detail. However, this is not intended to limit the technology described below to a particular embodiment form. On the contrary, the present disclosure is to be understood to include all various alternatives, equivalents, and substitutes that may be included within the spirit and technical scope of the technology described below.

Terms such as first, second, A, B, etc. may be used to describe various components, but the corresponding components are not limited by the terms, and are used only for the purpose of distinguishing merely one component from another component. For example, without departing from the scope of the technology described below, a first component may be referred to as a second component, and similarly, the second component may be referred to as the first component. The term “and/or” includes a combination of a plurality of related and described items, or any of the plurality of related and described items.

In the terms used in the present specification, singular expressions should be understood to include plural expressions unless the context clearly interprets otherwise. It should be understood that the terms such as “includes”, “comprises”, and the like mean that the described feature, number, step, operation, component, part, or combination thereof exists, but do not preclude possibilities of the presence or addition of one or more other features, numbers, steps, operations, components, parts, or combinations thereof.

Prior to a detailed description of the drawings, it should be clarified that the classification of components in the present specification is merely a classification for each main function of each corresponding component. That is, it may be provided such that two or more components described below may be combined into one component, or one component may be divided into two or more components for each more subdivided function. Further, in addition to its corresponding main function, each component described below may additionally perform some or all of the functions of other components, and naturally, a part of the corresponding main function of each component may also be exclusively performed by other designated components.

In addition, in performing a method or method of operation, each process constituting the method may be performed in a different order from a specified order unless a specific order is clearly described in context. That is, each process may be performed in the same order as specified, may be performed substantially simultaneously, or may be performed in a reverse order.

The technology described below is a technique for analyzing correlations between an image and a text prompt, which are generated by using a text-to-image generative model. The technique described below is capable of tracking and quantifying correlations between a local area of the generated image and the text prompt.

Various types of text-to-image generative models have been developed. For example, the text-to-image generative models include Generative Adversarial Networks (GAN), Variational Autoencoders (VAE), and other models based on diffusion models. Meanwhile, a Stable Diffusion model is representatively a Latent Diffusion Model (LDM). The technique described below may be applied to any one of various types of the text-to-image generative models.

In the following description, it is described that an analysis device analyzes correlations between a generated image and a text prompt. The analysis devices may be physically implemented with various types of devices, such as PCs, smart devices, network servers, and data processing chipsets.

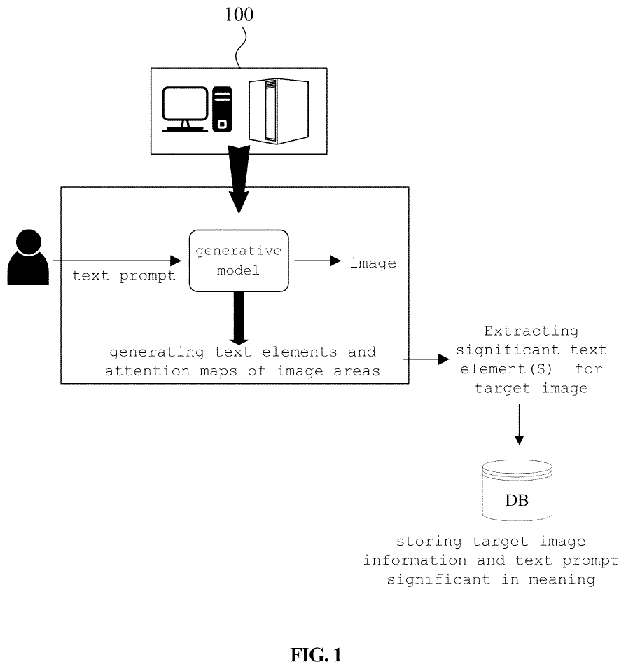

FIG. 1 is a view illustrating an example of a system for analyzing correlations between a generated image and a text prompt. FIG. 1 illustrates an example in which an analysis device 100 is a computer terminal or a server.

The analysis device 100 stores a text-to-image generative model trained in advance. A user may input a certain text prompt into the analysis device 100 through an interface device. Alternatively, the user may transmit a certain text prompt to the analysis device 100 through a user terminal.

The analysis device 100 generates a certain image by inputting the text prompt into the generative model. The image that the user desires to generate by using the text prompt is named as a target image.

The analysis device 100 analyzes correlations between the text prompt and the target image during a process of generating the target image by the generative model. The analysis device 100 may analyze the correlation between each of text elements constituting the text prompt and the target image.

The analysis device 100 may extract the text elements, which are significant in generating the target image, by generating an attention map for each text element during the process of generating the target image by the generative model.

The analysis device 100 may store the significant text element(s) or information (i.e., an annotation) for generating the target image. The analysis device 100 may store the text prompt or the text elements thereof, which are significant to the target image while analyzing correlations between various text prompts and the target image. Through this way, the analysis device 100 may create prompt candidates significant to the target image.

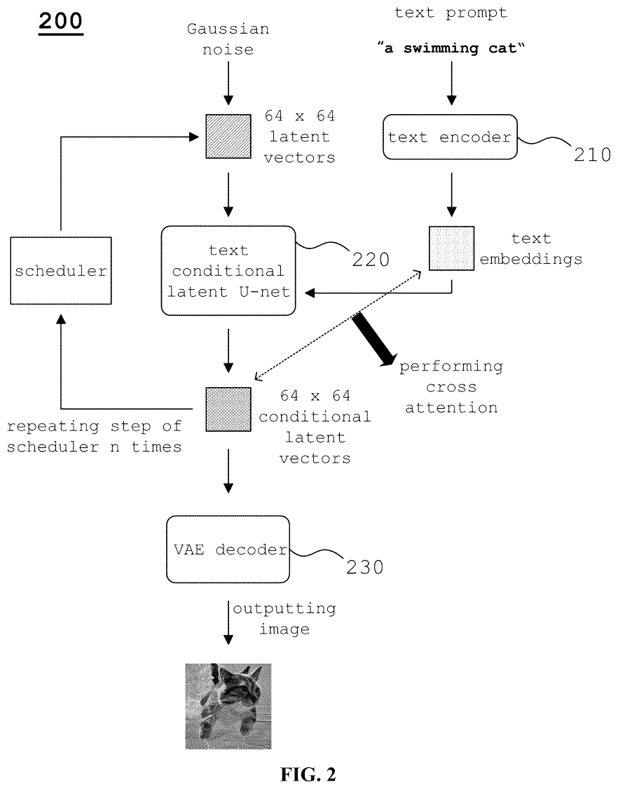

FIG. 2 is a view illustrating an example of a process of analyzing correlations between a generated image and a text prompt. The correlation between a target image and the text prompt can be analyzed by using LDM. FIG. 2 illustrates an LDM 200 as an example.

A diffusion model is a model trained through a forward process where noise is added to an input image and a backward process where an image is restored from the image added with the noise. The image with added noises is referred to as a noise image hereinafter.

The LDM is a model for restoring an image from latent vectors rather than noise.

A text encoder 210 tokenizes a text prompt and generate text embeddings in a form of latent vectors. The text encoder 210 may use various models (e.g., CLIP) or layers for the text embeddings. A text prompt may be text such as “a swimming cat”.

A text conditional latent U-net 220 fundamentally receives latent vectors having a certain size thereof and generated from random Gaussian noise, and text embeddings.

A scheduler controls a process of removing noise from the vectors. The scheduler repeats the process of adding noise to the image by setting intensities of noise, types of noise, probability partial differential equations, etc. with constant values, respectively.

The text conditional latent U-net 220 performs a process of removing noise (i.e., denoising) by repeatedly applying random latent vectors n times with conditioning based on the text embeddings. The text conditional latent U-net 220 is conditioned by the text embeddings and generates information about the target image on the basis of text. After going through this process, the text conditional latent U-net 220 may generate low-resolution (e.g., at 64×64 resolution) conditional latent vectors.

A decoder 230 of Variational AutoEncoder (VAE) receives the conditional latent vectors. The decoder 230 of the VAE corresponds to a decoder of VAE that has been previously trained to generate an image on the basis of the input latent vectors. The VAE decoder 230 outputs a target image corresponding to the text prompt.

Through this process, the analysis device analyzes the correlation between the text prompt and the target image. The analysis device generates attention maps during the denoising process performed by the text conditional latent U-net 220. The analysis device may generate cross attention maps during the denoising process. The cross attention maps represent correlations between the text embeddings and the conditional latent vectors.

$$Attention ( Q , K , V ) = softmax ( \frac{{QK}^{T}}{\sqrt{d}} ) \cdot V \qquad [ Equation 1 ]$$

The above Equation is an example of attention. Q denotes query, K denotes key, and V denotes value. In cross attention, keys and values are equal. Q indicates the conditional latent vectors in the process of the stable diffusion model or the noise image of the diffusion model. K and V are text embeddings. In this case, Q, K, and V may be values obtained by multiplying them by a weighting matrix having a certain size. The cross attention may obtain values by using a dot product in the denoising process to find similarities between Q (the noise image or conditional latent vector) and K (the text embeddings), passing the similarities through a Softmax function, and then calculating a dot product of V (the text embeddings) and weights generated by the passing of the similarities.

In this case, the analysis device may generate cross attention maps by performing the cross attention for each text element constituting the text prompt.

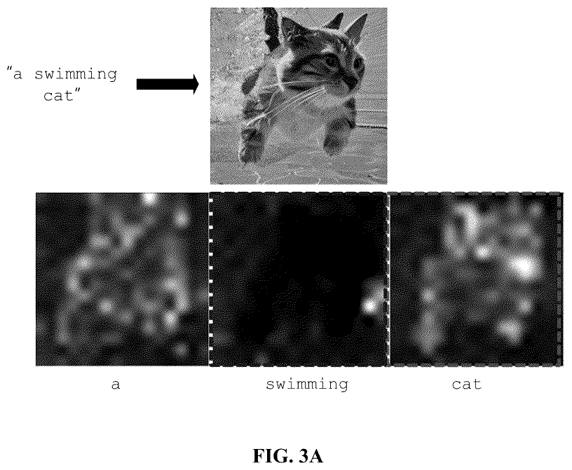

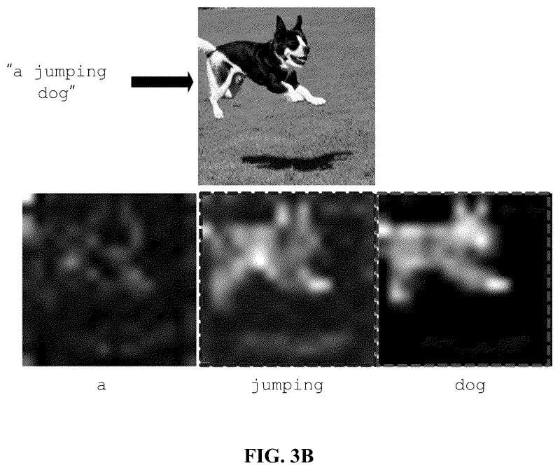

FIGS. 3A and 3B are views illustrating examples of cross attention maps between images and respective text prompts thereof, which are generated with a text-to-image generative model.

FIG. 3A illustrates an example of generating an image by inputting a text prompt as “a swimming cat”. The upper part of FIG. 3A illustrates the text prompt and the generated image. The lower part of FIG. 3A illustrates cross attention maps between respective text elements of the text prompt and noise image (i.e., conditional latent vectors).

FIG. 3B illustrates an example of generating an image by inputting a text prompt “a jumping dog”. The upper part of FIG. 3B illustrates the text prompt and a generated image. The lower part of FIG. 3B illustrates cross attention maps between respective text elements of the text prompt and noise image (i.e., conditional latent vectors).

Referring to FIGS. 3A and 3B, it may be seen that meaningless words such as articles belonging to the text prompt are given attention similar to that of surrounding words.

Furthermore, the analysis device may perform labeling on the generated image. A specific data set may be used for image generation. For example, when using a COCO data set, the analysis device may randomly generate a class list identical to the corresponding data set, so that an input text prompt is classified into a class when these are the same. Likewise, the analysis device may automatically label an action when an input text prompt is the same as the action in an action list in the corresponding data set as well. In FIGS. 3A and 3B, the attention maps for actions are shown in blue, and the attention maps for classes are shown in red.

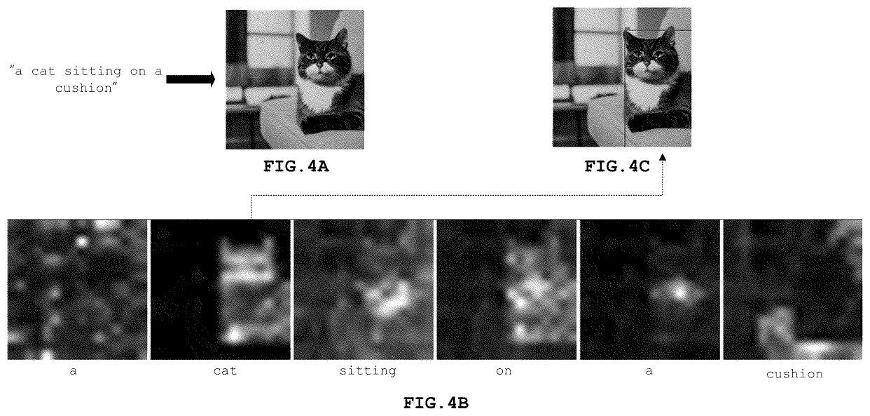

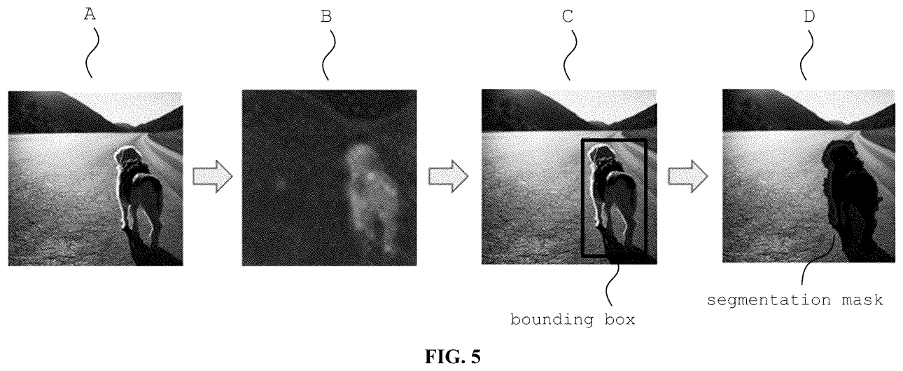

FIGS. 4A to 4C are views illustrating another example of cross attention maps between an image and a text prompt thereof, which are generated with a text-to-image generative model.

FIG. 4A illustrates an example of generating an image by inputting a text prompt as “a cat sitting on a cushion.

The analysis device may analyze correlations between the text prompt and an area of a target image. FIG. 4B illustrates cross attention maps between respective text elements of the text prompt and noise image (i.e., conditional latent vectors). Referring to FIG. 4B, it may be seen that meaningless words such as articles and a preposition in the text prompt are given attention similar to that of surrounding words. When correlations between the generated image and the text prompt in FIG. 4B are tracked, it may be seen that an area where an object prompt such as cat and cushion is definite has a high correlation (i.e., cross attention). In addition, it may be seen that “sitting” as a prompt corresponding to an action has a strong correlation with an area where the cat is sitting.

Furthermore, the analysis device may apply a bounding box to an area and annotate the area, which is related to a specific object or action. For example, based on an area (i.e., a white area) with a strong correlation in an attention map for a text prompt named “cat”, the analysis device may set the bounding box for the same area in a target image. In addition, the analysis device may provide an annotation (i.e., “cat”) for a bounding box area.

In addition, the analysis device may perform pixel-level segmentation on the basis of an attention map.

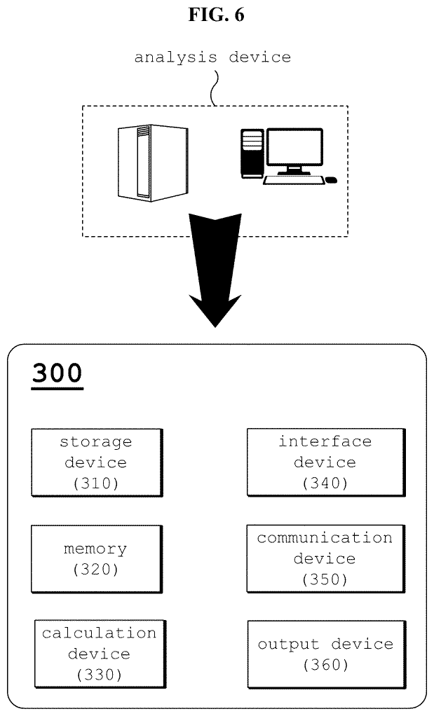

FIG. 5 is a view illustrating an example of area detection or segmentation using a generated image and an attention map. View A in FIG. 5 is the image generated on the basis of a text prompt. View B is the attention map generated through cross attention between a main text element (“dog”) of the text prompt and a noise image. View C is an example of bounding box labeling for an area where the expected object (i.e., the dog) exists on the basis of the attention map of View B. View D is an example of calculating a segmentation mask for the expected object (i.e., the dog) on the basis of the attention map. The analysis device may generate a segmentation mask on the basis of pixels or the area corresponding to the object in the attention map. The analysis device may generate the segmentation mask on the basis of the attention map within a bounding box area.

FIG. 6 is a view illustrating an example of an analysis device 300 for analyzing correlations between a generated image and a text prompt. The analysis device 300 in FIG. 6 corresponds to the analysis device 100 in FIG. 1. The analysis device 300 analyzes correlations between text and a noise image in a process of generating a target image as in the process of FIG. 2.

The analysis device 300 may be physically implemented in various forms. For example, the analysis device 300 may take the form of a computer device such as a PC, a network server, or a chipset dedicated to data processing.

The analysis device 300 may include a storage device 310, a memory 320, a calculation device 330, an interface device 340, a communication device 350, and an output device 360.

The storage device 310 stores a trained text-to-image generative model. The text-to-image generative model may be a generic Diffusion model or a Stable Diffusion model. The Stable Diffusion model may be any one of various types of models.

The generic diffusion model can be any of various types of models. The generic diffusion model generates the noise image by adding noise to an input image, and produces an output image with a probability distribution similar to that of the input image from the noise image.

The Stable Diffusion model is a model trained to restore (or generate) an image through a process of generating conditional latent vectors by injecting noise into an input image in a latent space and generate an image from the from the noise image. The Stable Diffusion model receives a text prompt and generates a target image from latent vectors generated conditional on text content.

The storage device 310 may store a text prompt that is input by a user.

The storage device 310 may store a target image generated by the Stable Diffusion model.

The memory 320 may store data, information, etc., which are generated in the process of analyzing correlations between the generated image and the text prompt.

The interface device 340 is a device for receiving certain commands and data from the outside.

The interface device 340 may receive a trained text-to-image generative model.

The interface device 340 may receive a text prompt.

The interface device 340 may transmit a generated target image to an external object.

The interface device 340 may transmit a target image or text elements thereof correlated with a local area of the target image to an external object.

The interface device 340 may be a component for transmitting data received from the communication device 350 to the inside of the analysis device 300.

The communication device 350 refers to a component for receiving and transmitting predetermined information through a wired or wireless network.

The communication device 350 may receive a trained text-to-image generative model.

The communication device 350 may receive a text prompt.

The communication device 350 may also transmit a target image or text elements thereof correlated with a local area of the target image to an external object such as a user terminal or a service server.

The calculation unit 330 receives a text prompt and inputs this text prompt into the text-to-image generative model. The text-to-image generative model may be the generic Diffusion model or the Stable Diffusion model.

The calculation unit 330 can generate text embeddings of the text prompt from an encoder inputting the text prompt.

The calculation unit 330 can analyze the correlations between the text embeddings of the text prompt and the noise image. The calculation unit 330 can perform cross-attention between the text embeddings and the noise images to generate an attention map.

The calculation unit 330 analyzes correlations between text embeddings generated from the text prompt and the conditional latent vectors generated during the process of the text-to-image generative model. The calculation device 330 may generate attention maps by performing cross attention between the text embeddings and the conditional latent vectors.

The calculation device 330 may generate the attention maps by performing the cross attention between the conditional latent vectors and respective text elements (i.e., words or syllables) constituting a text prompt.

The calculation device 330 may generate a cross-attention map for each text element.

The calculation device 330 may generate a cross-attention map using a softmax function for a dot product with (i) a similarity between the conditional latent vector and a text elements and (ii) the text element. The cross-attention map can indicate the association between the text element and specific regions of the target image. The cross-attention map or the result of the cross-attention indicates the degree of correlation between the specific text element and a specific area of a target image.

The calculation device 330 may analyze the degree of correlation between a specific text element and a specific area of a target image. The calculation device 330 may evaluate or quantify whether the specific text element is contributing to the target image or object.

The calculation device 330 may extract text element(s) that contribute (or have significance in meaning) to the target image generation. The calculation device 330 may store the text elements significant to the specific target image in the storage device 310.

The calculation device 330 may use an attention map to distinguish a specific area (i.e., to set a bounding box) of the target image correlated with the text elements.

For the area distinguished by using the attention map, the calculation device 330 may annotate the specific area by using a corresponding text element.

The calculation device 330 may perform segmentation of the area related to the corresponding text element on a pixel-by-pixel basis by using the attention map.

An attention map is binarized so that a specific area appears white on a black background. The calculation device 330 may quantify the degree of correlation between the specific area and the text element on the basis of the number of white pixels or the density thereof in the attention map.

The calculation device 330 may analyze the degrees of correlation between a specific target image or an object in the target image and specific text elements, and may select a text element significant to the target image. The calculation device 330 may select, as a significant text element, a text element whose correlation with the specific target image or the object in the target image is greater than or equal to a threshold value. Through this process, the calculation device 330 may prepare text prompt candidates in advance that contribute to the generation of high-quality target images. Afterwards, the text prompt candidates may be used as information for generating images targeted by other users.

The calculation device 330 may be a device such as a processor, an AP, or a chip with an embedded program, which are for processing data and performing predetermined calculations.

The output device 360 is a device for outputting predetermined information. The output device 360 may output attention maps for text elements of a text prompt.

The output device 360 may distinguish or annotate a specific area in a target image on the basis of attention maps for respective text elements. Through this way, a user may determine the degrees of correlation between specific text elements and the attention maps or distinguished areas of the target image.

In addition, as described above, a method for analyzing correlations between an image and a text prompt or a method of creating a text prompt significant in meaning may be implemented as a program (or an application) including an executable algorithm capable of being executed on a computer. The program may be stored and provided in a transitory or non-transitory computer readable medium.

The non-transitory readable medium refers to a medium that stores data semi-permanently and may be read by a device, rather than a medium that stores data for a short period of time, such as registers, caches, and memories. Specifically, the various applications or programs described above may be stored and provided in the non-transitory computer readable medium such as a CD, a DVD, a hard disk, a Blu-ray disk, a USB, a memory card, a read-only memory (ROM), a programmable read only memory (PROM), an Erasable PROM (EPROM) or an Electrically EPROM (EEPROM), or a flash memory.

The transitory computer readable medium refers to various random access memories (RAMs) such as a static RAM (SRAM), a dynamic RAM (DRAM), a synchronous DRAM (SDRAM), a double data rate SDRAM (DDR SDRAM), an enhanced SDRAM (ESDRAM)), a Synclink DRAM (SLDRAM)), and a direct Rambus RAM (DRRAM).

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method for analyzing a degree of correlation between an image and a text prompt, which are generated by a generative model, the method comprising:
receiving the text prompt by an analysis device;
inputting the text prompt into the text-to-image generative model by the analysis device;
calculating, by the analysis device, degrees of correlation between text elements in the text prompt and conditional latent vectors for each text element; and
determining, by the analysis device, at least one text element among the text elements for generating the image if the degrees of correlation for the at least on text element is greater than a threshold value,
wherein the conditional latent vectors are generated in a process of generating the image by the text-to-image generative model.

2. The method of claim 1, wherein the text-to-image generative model is a Stable Diffusion model.

3. The method of claim 1, wherein the analysis device calculates the degrees of correlation on the basis of attention maps generated by performing cross attention between the conditional latent vectors and the at least one text element.

4. The method of claim 1, wherein the analysis device calculates the degrees of correlation on the basis of attention maps generated by performing cross attention between text embeddings generated by a text encoder receiving the text prompt in the process of generating the image and the conditional latent vectors generated conditional on the text embeddings.

5. The method of claim 3, wherein the analysis device distinguishes or segments an area where the at least one text element is positioned in the image on the basis of the attention maps.

6. An analysis device for analyzing a degree of correlation between an image and a text prompt, the analysis device comprising:
an interface device configured to receive input of the text prompt;
a storage device configured to store a text-to-image generative model for generating an image on the basis of text information; and
a calculation device configured to select at least one text element among the text elements in the text prompt based on degrees of correlation between conditional latent vectors and the at least one text element, wherein the conditional latent vectors are generated in a process of generating the image by the text-to-image generative model which input the text prompt.

7. The analysis device of claim 6, the text-to-image generative model is a Stable Diffusion model.

8. The analysis device of claim 6, wherein the calculation device calculates the degrees of correlation on the basis of attention maps generated by performing cross attention between the conditional latent vectors and the at least one text element.

9. The analysis device of claim 6, wherein the calculation device calculates the degrees of correlation on the basis of attention maps generated by performing cross attention between text embeddings generated by a text encoder receiving the text prompt in a process of generating the image and conditional latent vectors generated conditional on the text embeddings.

10. The analysis device of claim 8, wherein the calculation device distinguishes or segments an area where the at least one text element is positioned in the image on the basis of the attention maps.
